(19) United States
(12) Patent Application Publication
(10) Pub. No.: US 2018/0188907 A1
(43) Pub. Date: Jul. 5, 2018

(54) CONTENT ITEM STATE RETRIEVAL SYSTEM

(71) Applicant: Microsoft Technology Licensing, LLC, Redmond, WA (US)

(72) Inventors: Michael Walter Golembewski, Cambridge (GB); Siân Elizabeth Lindley, Cambridge (GB); Samuel Gavin Smyth, Cambridge (GB); Robert Corish, London (GB); Ewa Anna Luger, Cambridge (GB); Maria Kustikova, Moscow (RU)

(21) Appl. No.: 15/399,709

(22) Filed: Jan. 5, 2017

(51) Int. Cl. G06F 3/0482; H04L 12/58; G06F 17/30

(52) U.S. Cl. CPC G06F 3/0482; H04L 51/04; H04L 51/16; G06F 17/2288; G06F 17/30699; G06F 17/30696; H04L 51/12

(57) ABSTRACT

In various examples there is an electronic device having a content item state retrieval system. There is a chat interface executing at the electronic device and a processor which monitors states of at least one content item associated with the electronic device in relation to chat messages at the chat interface. A logging component logs associations between at least some of the content item states and the chat messages based on the times at which the chat messages were created; and a user interface has selectable elements representing the chat messages. When an element is selected by a user it triggers retrieval of an associated state of a content item based on the logged associations.

### BACKGROUND

Information retrieval systems typically have a query input mechanism whereby a user types a query comprising one or more key words for input to the information retrieval system. The key words are then used to retrieve links to documents or other content which is relevant to the key words. However, it is often difficult for end users to type the key words where the electronic device being used has a small form factor, such as in the case of a tablet computer, smart watch, smart phone and other mobile devices. Another problem is that it is difficult for end users to know what key words to use. For example, the user may not recall the exact content item to be retrieved and/or may not recall appropriate key words or other features about the content item.

In the case of information retrieval where a user desires to search using criteria such as date ranges, type of content, author of content, and other criteria, the end user has to enter those criteria into the electronic device such as by typing or other manual input. The syntax to be used to enter the criteria often has particular forms which must be used and which are not familiar or easy to use on the part of the end user. The burden of entering the criteria to the electronic device is significant, especially for novice users and users who infrequently enter search criteria.

The embodiments described below are not limited to implementations which solve any or all of the disadvantages of known retrieval systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is an electronic device having a content item state retrieval system. There is a chat interface executing at the electronic device and a processor which monitors states of at least one content item associated with the electronic device in relation to chat messages at the chat interface. A logging component logs associations between at least some of the content item states and the chat messages based on the times at which the chat messages were created; and a user interface has selectable elements representing the chat messages. When an element is selected by a user it triggers retrieval of an associated state of a content item based on the logged associations.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a tablet computer with a retrieval engine being used by an end user to chat with an end user of a smart watch, and to retrieve states of a content item;

FIG. 2 is a schematic diagram of a content item state timeline for a text file containing one line of text;

FIG. 3 is a schematic diagram of a text chat timeline;

FIG. 4 is a schematic diagram of links between states of a content item and chat messages;

FIG. 5 is a schematic diagram of a user interface comprising a document state timeline and a chat history with linked document state;

FIG. 6 is a flow diagram of a method of operation at a logging component and retrieval engine;

FIG. 7 is a flow diagram of another method of operation at a logging component;

FIG. 8 is a schematic diagram of a user interface comprising a document state timeline and a chat history with linked document state, showing addition of a milestone to the chat history;

FIG. 9 is a is a schematic diagram of a user interface comprising a document state timeline and a chat history showing scrolling back the chat history;

FIG. 10 is a schematic diagram of a user interface comprising a document state timeline and a chat history showing jumping to a previous milestone;

FIG. 11 is a schematic diagram of a user interface comprising a document state timeline and a chat history showing selecting of an element on the document state timeline;

FIG. 12 is a schematic diagram of a user interface comprising a document state timeline and a chat history showing chat scrolling in synchrony with the document state timeline;

FIG. 13 is a schematic diagram of deselecting a milestone to return to the current state of a content item;

FIG. 14 illustrates an exemplary computing-based device in which embodiments of a retrieval engine are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

Although the present examples are described and illustrated herein as being implemented in a text-based chat system, the system described is provided as an example and not a limitation. As those skilled in the art will appreciate, the present examples are suitable for application in a variety of different types of chat systems including video chat systems.

It is recognized herein that existing information retrieval systems are poor at enabling end users to retrieve particular states of content items, such as particular versions of documents or other content items. A content item state is a condition of a document, video, image, or other content item at a particular time. The state of a content item is able to change over time, for example, as one or more actions are performed on the content item, such as editing, deleting, publishing, sending, receiving, encoding, decoding, or other actions.

It is recognized herein that retrieving particular individual states of content items is extremely difficult for end users for a variety of reasons. Often the only way the individual states can be differentiated is by the time of the individual states. End users find it very difficult to accurately recall times associated with content item state and as a result it is difficult to use time as a query input to traditional information retrieval systems. Even if a time range is used to search there may be many search results for the end user to choose between. As the different states of a content item are typically very similar, keywords cannot be used easily to search for individual states of the content item. Often the end user has to spend time assessing the content of many states of a content item in order to locate a target content item state (i.e. the content item state he or she wants). Therefore there is significant manual burden on the end user of inputting a search query, and selecting individual search results to assess those fully. The end user has to repeatedly refine the search in order to find the target content item state.

Where teams of people are involved in authoring content the problems are further exacerbated. This is because often different team members are involved with creating different content item states. Thus an individual team member has detailed knowledge about some but not all of the content item states. Typically an individual member of the team has no good way to recall search criteria to retrieve a target state of the content where that target state was generated by a different member of the team.

The present technology stores content item states in association with chat messages. The associations or links are used to facilitate efficient and accurate retrieval of content item states and/or chat messages. Selectable elements representing the chat messages are generated at a user interface. When a user selects one of the elements retrieval of an associated state of a content item is triggered. In this way a user is able to retrieve a desired content item state with a single user input action. Data entry to the electronic device is facilitated so that an end user operating a smart watch, or other mobile electronic device, is able to accurately and simply retrieve content item states. The selectable elements representing the chat messages comprise icons associated with chat messages in some examples. When the user understands the content of the chat messages he or she is able to recall which chat message is associated with the time of the content item state he or she is trying to find.

In some examples, the chat message selectable elements are arranged in a timeline. A timeline is a linear graphical arrangement of elements representing chronological order of the elements. Use of a timeline facilitates ability of the end user to find a chat message associated with a particular content item state. In some cases the timeline comprises details of milestones, which are content item states meeting particular criteria. For example, a content item state which is a milestone is labeled as such by an end user. A milestone provides a means for a user to tag a content item state at a particular moment in time. A milestone thus supports later retrieval of the tagged content item state and chat as it was at that moment. Milestones may be added in any suitable way such as directly to the content item state timeline 122 or via the chat interface 118. When a user selects a milestone in the document state timeline 122 the retrieval engine 102 acts to cause the content item state and chat associated with the selected milestone to be displayed, in the same way as if the user had navigated the chat history and selected the milestone from the chat history.

In some cases the timeline comprises details of particular events, such as publication or sharing of a content item state. Adding milestones and content item state events to the chat timeline helps end users quickly find relevant chat messages needed to retrieve particular content item states.

In some examples selectable elements representing content item states are generated at a user interface. When a user selects one of the content item state elements, retrieval of an associated content item state and associated chat messages is triggered.

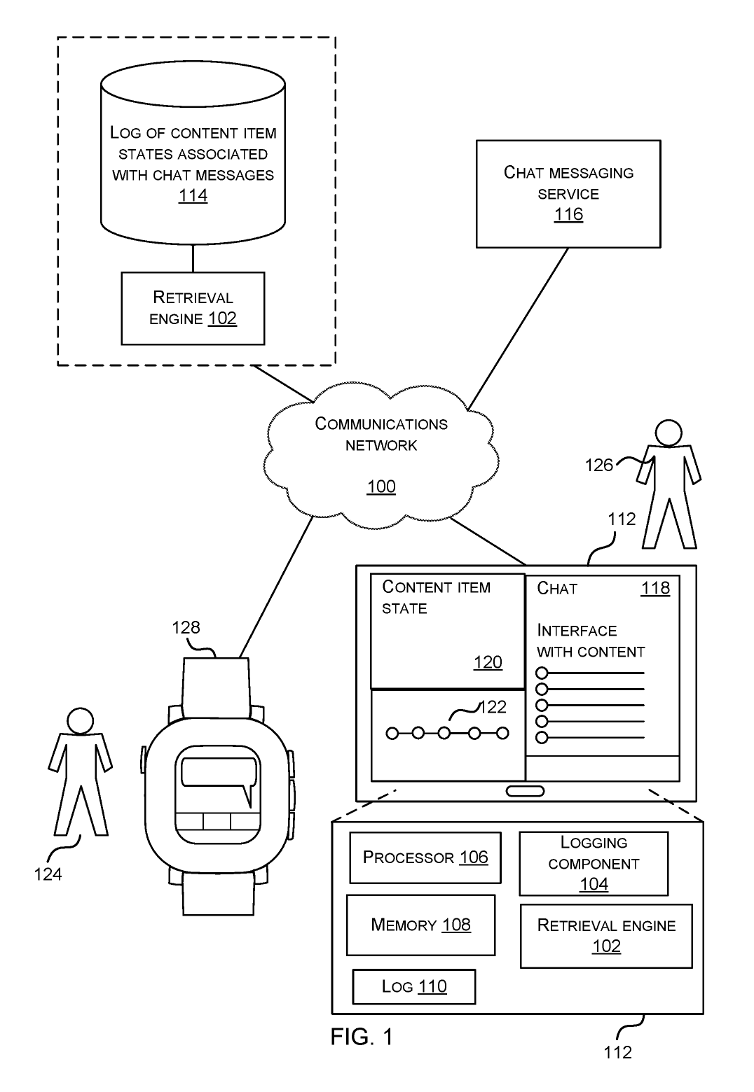

FIG. 1 is a schematic diagram of a first author 126 operating a tablet computer 112 to co-author a content item 120 with a second author 124 operating a smart watch 128. A chat messaging service 116 is available to the smart watch 128 and the tablet computer 112 via a communications network 100 such as the internet or any other communications network to which the smart watch 128 and tablet computer 112 are connected by a wireless or wired connection. The authors 124, 126 have an ongoing communication link using the chat messaging service 116 about how they are authoring the content item 120.

The tablet computer and the smart watch each have a processor 106, memory 108, log 110, logging component 104 and retrieval engine 102 although these are only shown for the tablet computer in FIG. 1 for clarity. The logging component 104 monitors content item states at the electronic device (tablet computer or smart watch) and stores these together with associated chat messages occurring in the chat communication link between the tablet computer 112 and the smart watch 128. The stored information is held at log 110 at the electronic device and/or at a remote entity 114 accessed via the communications network 100.

The retrieval engine 102 generates a chat interface 118 with content state links. For example, this is a chronological list of chat messages sent or received where individual ones of the chat messages are linked to content item states. When a user selects one of the chat messages the retrieval engine triggers retrieval of the linked content item state. The retrieval engine uses the information in the log 110 at the electronic device and/or at the remote entity 114 to retrieve the linked contend item state which is displayed to the user, for example, by presenting the content item state at viewing pane 120 of the user interface.

The retrieval engine generates a content item state timeline 122 in some examples although this is not essential. The content item state timeline 122 comprises a plurality of elements representing content item states. The elements are in chronological order and when a user selects one of the elements the associated content item state is presented in viewing pane 120 and the linked chat message(s) are presented in the chat interface 118.

In some examples, some or all of the functionality of the retrieval engine 102 is at the remote entity 114 and accessed by the electronic devices via communications network 100. In examples where a single user has a plurality of associated electronic devices, the log 114 may be arranged to aggregate or associate the chat messages and content item states of the electronic devices associated with the user.

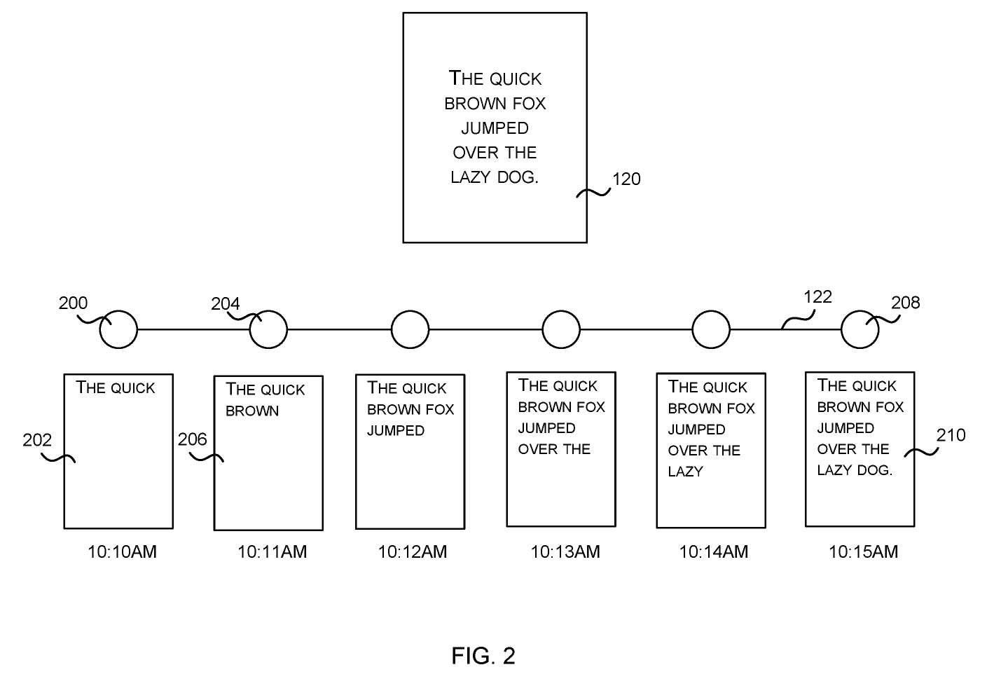

FIG. 2 is a schematic diagram of a content item state timeline for a text file 120 containing one sentence of text “The quick brown fox jumped over the lazy dog”. As mentioned above a content item state is a condition of a document, video, image, or other content item at a particular time. In the example of FIG. 2 the content item is a text file. As the user types in text to the text file different states 200, 204, 208 of the text file result as different amounts of text content are present in the file. In the example shown a state 202 of the text file at 10.10 am is a text file with the words “The quick”, whereas at 10.11 am the state 206 of the text file is a text file with the words “The quick brown”. The states of the text file are recorded and represented on a timeline 208 by elements 200, 204, 208. In the example shown the states are recorded every minute however this is not essential, states may be recorded at other regular intervals, or each time a change to the item is made. By selecting elements on the timeline 208 a user is able to retrieve the associated text file state.

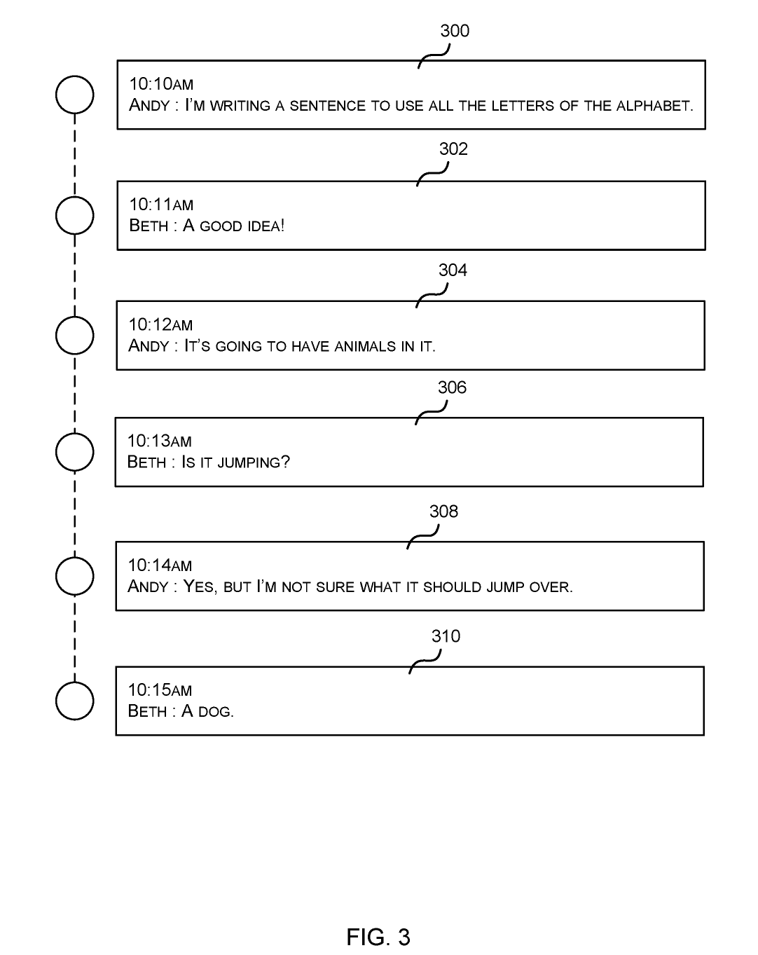

FIG. 3 is a schematic diagram of a text chat timeline taking place whilst the text file in FIG. 2 was written. The text chat timeline comprises a sequence of text chat messages 300-310 where each text chat message has an associated time at which the text chat message was created, and has a name of a creator of the text chat message as well as text content of the message. The sequence of text chat messages is represented as a timeline 312 in FIG. 3 comprising one element for each text chat message connected by a line. Although the example of FIG. 3 is for text chat, it is also possible to use video chat in which case each chat message is represented as a video thumbnail image on the timeline. It is also possible to have a mixture of text chat and video chat messages on the same timeline.

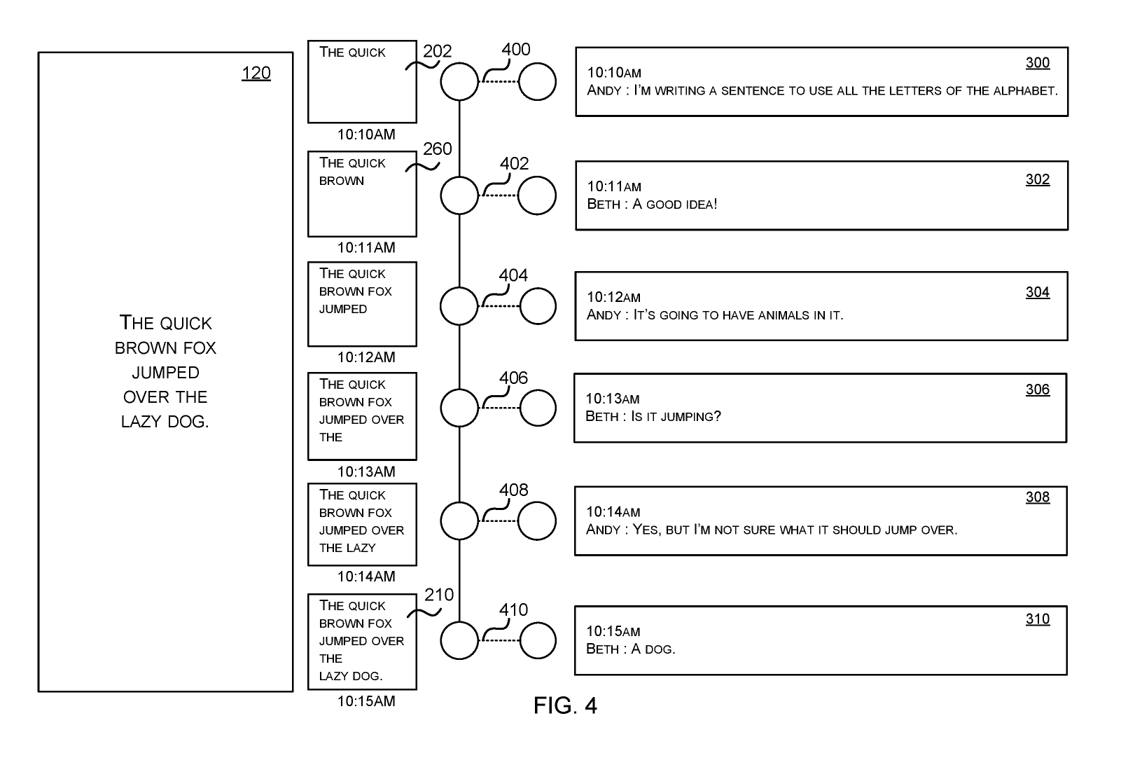

FIG. 4 is a schematic diagram of links 400-410 between states of a content item 202, 206, 210 and chat messages 300-310. The links represent associations between stored content item states and chat messages. A chat message and a content item state are linked, or stored in associated with each other, according to the time of creation of the chat message and the time of the content item state creation. For example, the link is created when these times are within a specified range of one another.

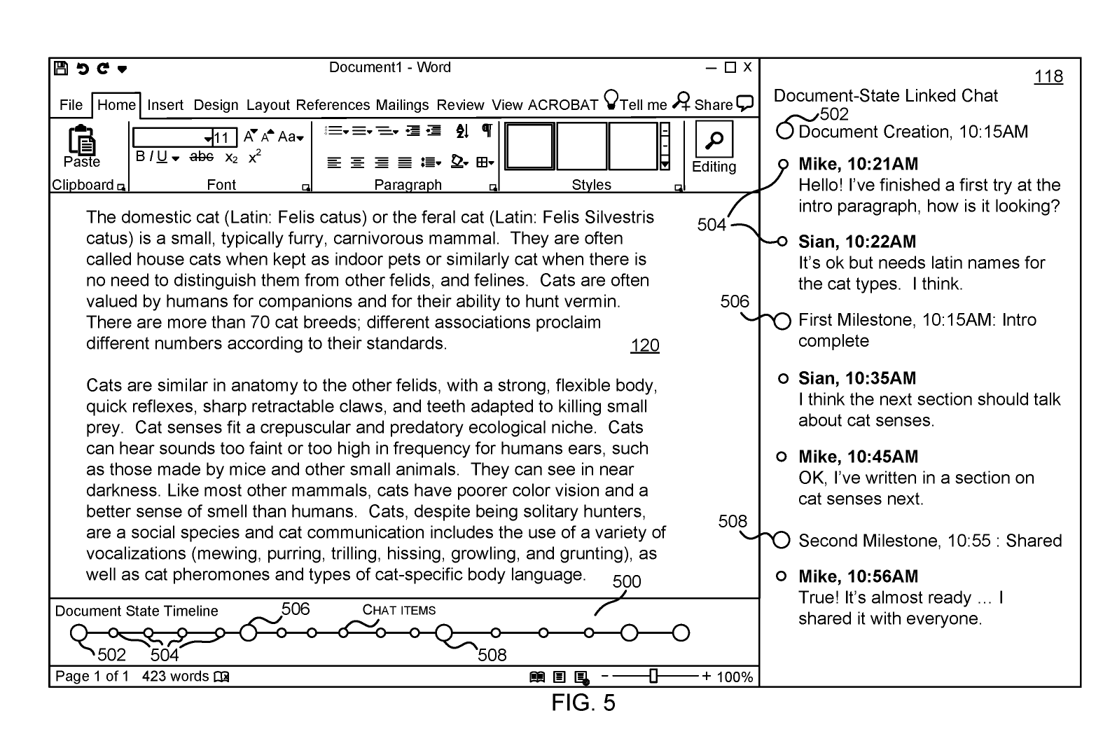

FIG. 5 is a schematic diagram of a user interface at a computing device comprising a content item state timeline (in this case a document state timeline) 500 and a chat history 118 with linked document state. A document authoring application is executing at the computing device such as any of the electronic devices of FIG. 1 or other electronic devices. Authors Mike and Sian are working together to author a document using the document authoring application and they are communicating using a chat messaging service. The resulting chat messages 504 are shown in chat interface 118. The document being authored is visible in document authoring pane 120.

As the content of the document has evolved during the authoring process a plurality of different states of the document have been saved and these are represented as circular elements on the document state timeline 500. An initial state 502 represents creation of the document at 10.15 am.

The content item states are classified into a plurality of possible classes in some examples. In the case of FIG. 5, at least some of the states 504 are of a first class represented by a smaller unfilled circle on the document state timeline. These first class of document states represent intermediate stages of the document. At least some of the states of the document are of a second class represented by a larger circle 506, 508 on the document state timeline and referred to as a milestone. The milestones are represented on the chat history timeline in appropriate chronological positions and with text indicating the nature of the milestone. Although this example uses two classes it is also possible to have more classes and the scope of the technology is not limited to two classes.

In some examples, where content item states are classified into a plurality of possible classes, the user is able to filter the display at the chat interface 118 and/or content item state 120 pane in order to display particular classes and/or ranges of classes. In some examples, the user is able to filter the display at the chat interface 118 and/or content item state pane 120 according to time ranges.

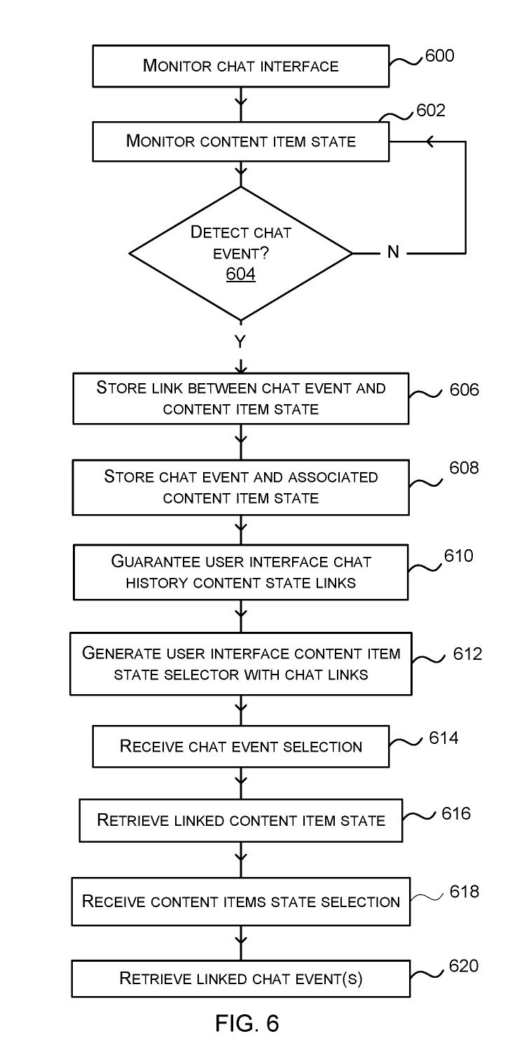

FIG. 6 is a flow diagram of a method of operation at an electronic device such as the smart watch or tablet computer or other electronic device of FIG. 1. A processor at the electronic device, or a remote entity in communication with the electronic device, monitors 600 a chat interface to detect chat messages sent or received by the electronic device. The chat interface is a dedicated chat messaging application executing on the electronic device, or any other chat messaging functionality available to the electronic device which enables it to send and receive chat messages. An individual chat message has an associated time which is a time of creation of the chat message.

The processor at the electronic device, or a remote entity in communication with the electronic device monitors 602 content item state at the electronic device. This involves checking for any changes in condition of content items at the electronic device, such as changes in parts of a web page being browsed, changes in content of a document being authored, images being captured, or other changes in content items.

The processor at the electronic device checks for chat messages 604 sent or received. If a sent or received chat message occurs a logging component 104 at the electronic device stores 608 the chat message and associated content item state at a log. For example, the associated content item state is the current state of the content item(s) at the electronic device at the time of the chat message, or within a specified time range of the chat message. In some cases the logging component stores the data at the electronic device and in some cases at a remote entity.

A retrieval engine at the electronic device or at a remote entity, generates 610 a user interface for display at the electronic device. The user interface has selectable elements representing the chat messages. The retrieval engine is configured so that when a selectable element representing a chat message is selected by a user the retrieval engine triggers retrieval of an associated state of a content item based on the log. In some examples the selectable elements representing the chat messages are arranged in a timeline.

The retrieval engine generates 612 selectable elements representing content item states in some cases, although this is not essential. For example, the selectable elements representing content item states are given on a timeline. In some cases the selectable elements representing content item states are interleaved on a timeline of chat messages.

The retrieval engine receives 614 user input selecting a chat message selectable element of the user interface. For example, the user input is a touch on a touch screen depicting a chat timeline, or is a spoken command, or a gesture, or an eye movement or any other type of user input. In response to the user input, the retrieval engine retrieves 616 the content item state which is linked or associated with the chat message based on the log. In the case that a single chat message is associated with two or more content item states and/or parts of content item states, the associated content item states are retrieved and may be displayed to a user, such as using several windows, one for each content item state. In an example, a part of a content item state is captured and logged by the logging component and comprises a current paragraph of a document. The user is able to choose to revisit the paragraph and/or the complete document from a chat message. In an example, a single chat message is associated with two or more separate content item states such two separate documents being viewed side by side in the same document viewer. When a user selects a chat message associated with the two content item states they are retrieved.

In some cases the retrieval engine receives 618 user input selecting a content item state selectable element of the user interface. In response to the user input the retrieval engine retrieves chat messages which are linked or associated with the content item state based on the log.

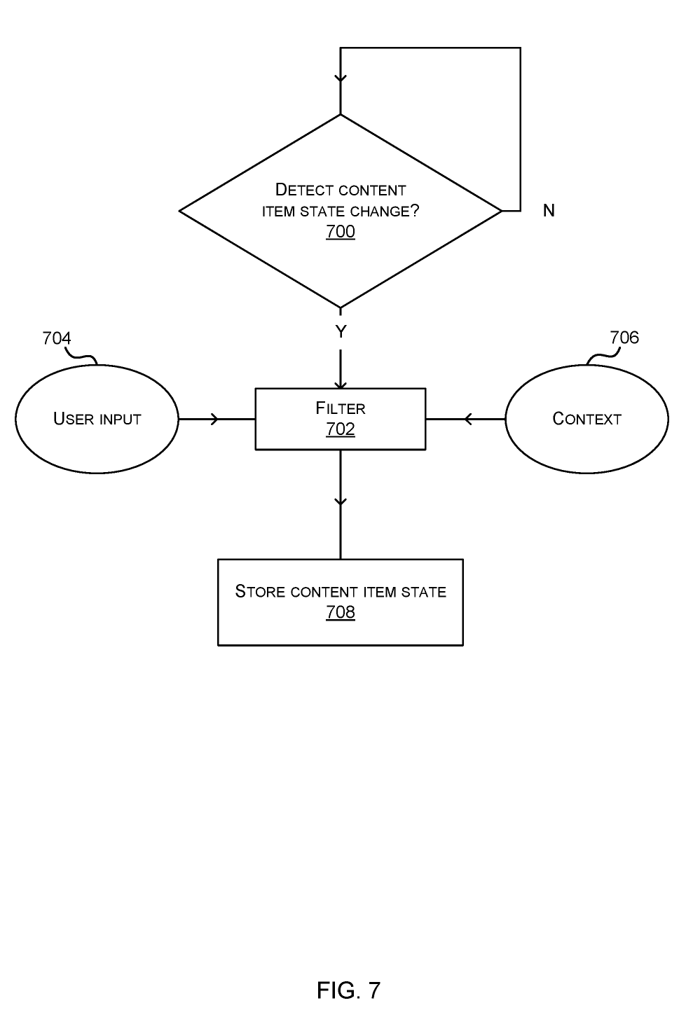

As mentioned above, a content item has different states depending on the condition of the content item. Different levels of granularity of content item state may be recorded in the log according to a trade-off between memory availability and ability to return to content item states of fine granularity. For example, at a very fine level of granularity, states of a text document may differ by a single character or key stroke, whereas at a higher level of granularity only changes involving creation of a new page are considered. In order to control this trade off the logging component has a filter 702 as now described with reference to FIG. 7.

If the logging component detects 700 a content item state change it passes the state change through a filter 702 which lets through some but not all of the content item stage changes. Content item state changes which pass through the filter 702 are stored 708 in the log. The filter is adaptable according to user input 704 and/or context 706. For example, user input specifying a degree of change between a content item state and a previous content item state is given. For example, user input specifying a time interval between content items states is given. For example, user input specifying a class label of a content item state is input, such as milestone labels. Context about content item state is also available in some cases. For example, information about other events (not chat messages) at the electronic device which occur at the same time as the content item state.

In some cases the filter 702 uses preconfigured rules. For example, to let through content item state where there is sharing or publication of the content item.

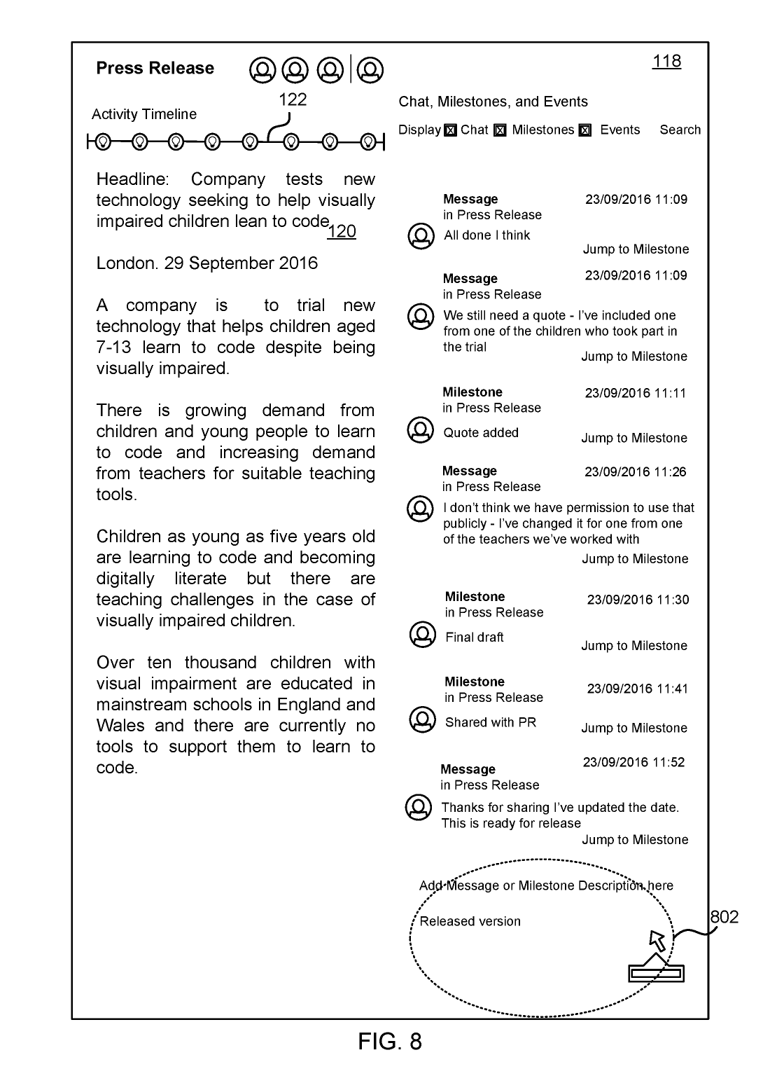

FIGS. 8 to 13 are schematic diagrams of an example user interface having a document state timeline 122 and a chat interface 118 with a chat timeline that links to document state. In the example of FIG. 8 the document state timeline 122 comprises eight elements representing eight states of the document shown in pane 120. Chat messages are shown in chat interface 118 comprising messages created by different members of a team of people who are collaboratively authoring document 120. One of the authors is in the process of adding a milestone to the chat timeline by entering text at field 800 and selecting icon 802. As a result a selectable element will be added to the chat timeline and/or content item state timeline 122 according to the time that the milestone was created. When a user selects the selectable element representing the milestone there is automatic navigating to the particular content state item and chat message(s) associated with the time of the milestone.

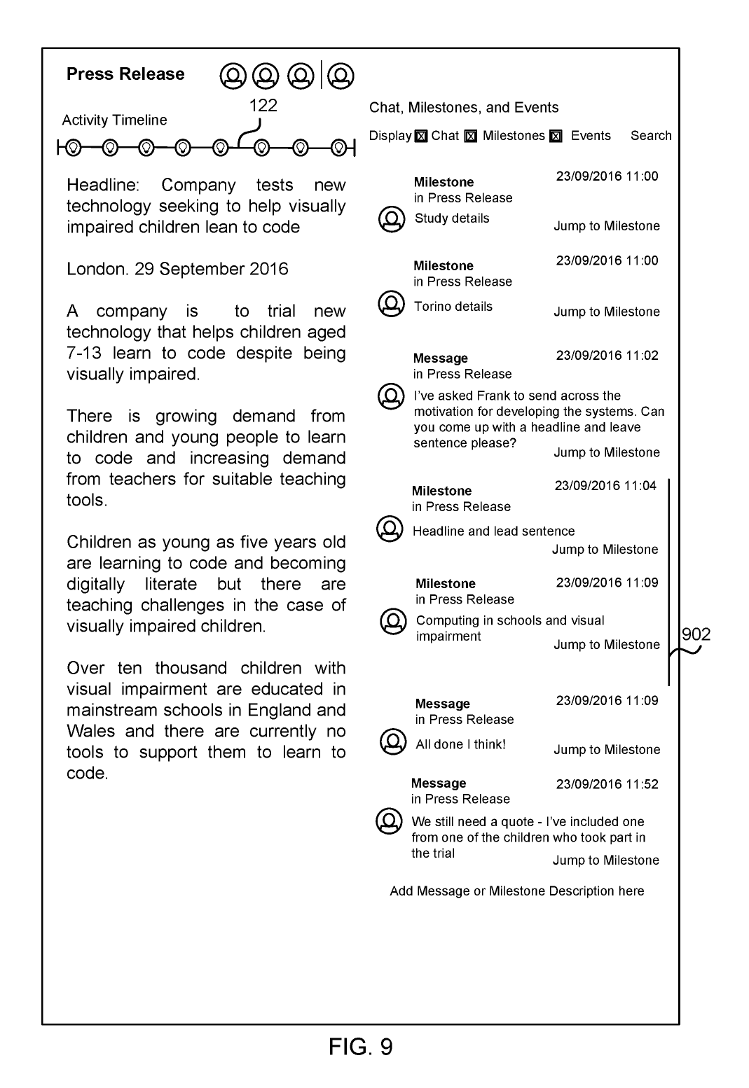

FIG. 9 shows the user interface of FIG. 8 in the situation where a user has scrolled back the chat timeline 118 to an earlier time (11.04 in this case). The document state in pane 120 is unchanged at this point since the user has not selected any of the selectable elements in the chat interface 118.

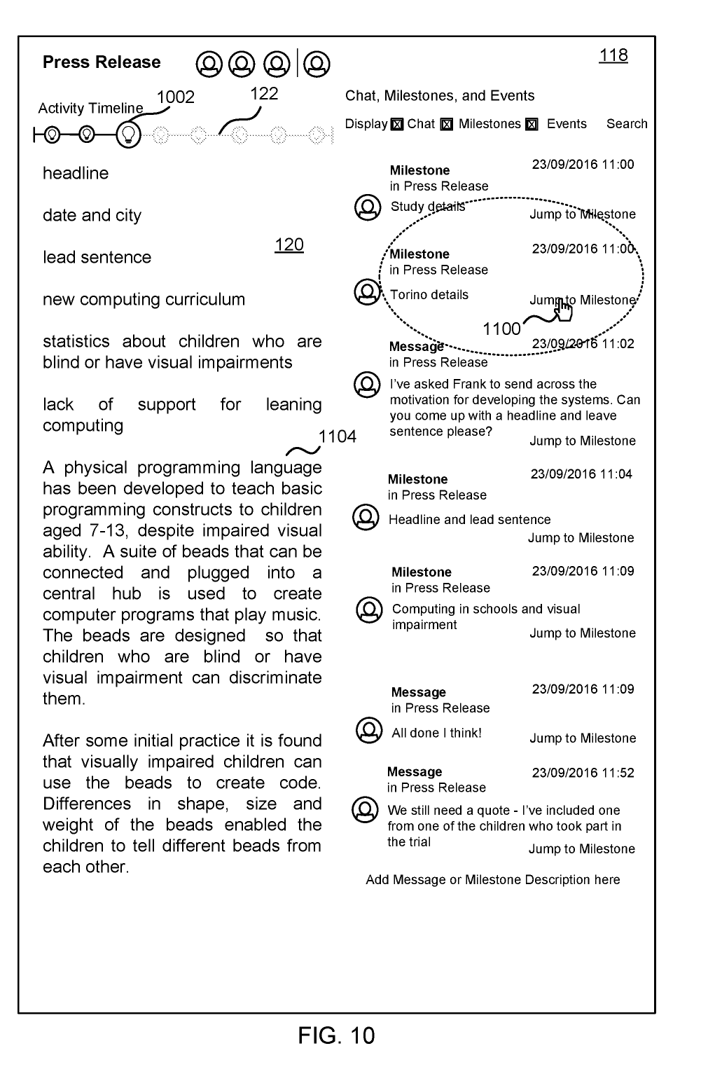

FIG. 10 shows the user interface of FIG. 8 in the situation where a user has selected a selectable element on the chat timeline, which represents a previous milestone 1000. The retrieval engine is therefore triggered to retrieve the associated document state 1104 which is displayed in pane 120. The document state timeline 122 updates to show the element representing the currently displayed document state enlarged and the later document states greyed out.

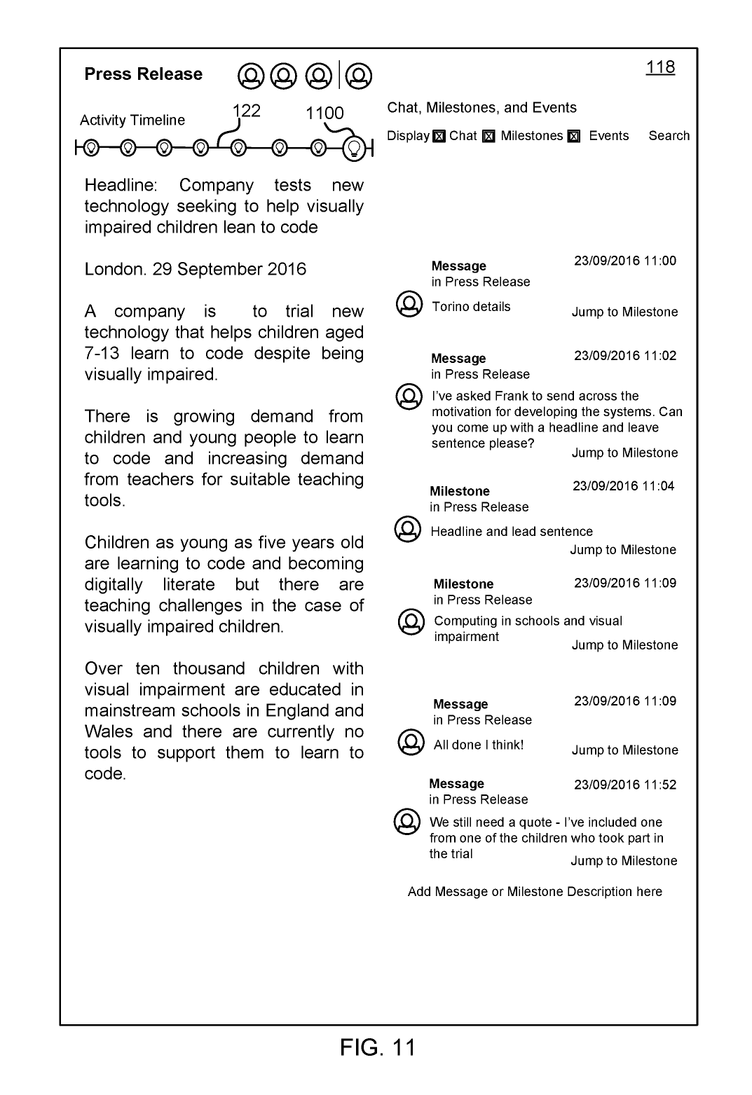

FIG. 11 shows the user interface of FIG. 8 in the situation where a user jumps to a milestone using the document state timeline 122. The user selects element 1100 on the document state timeline and this causes the associated document state to be retrieved and displayed in the document pane. In some examples the chat history also moves to show the associated chat history of the milestone.

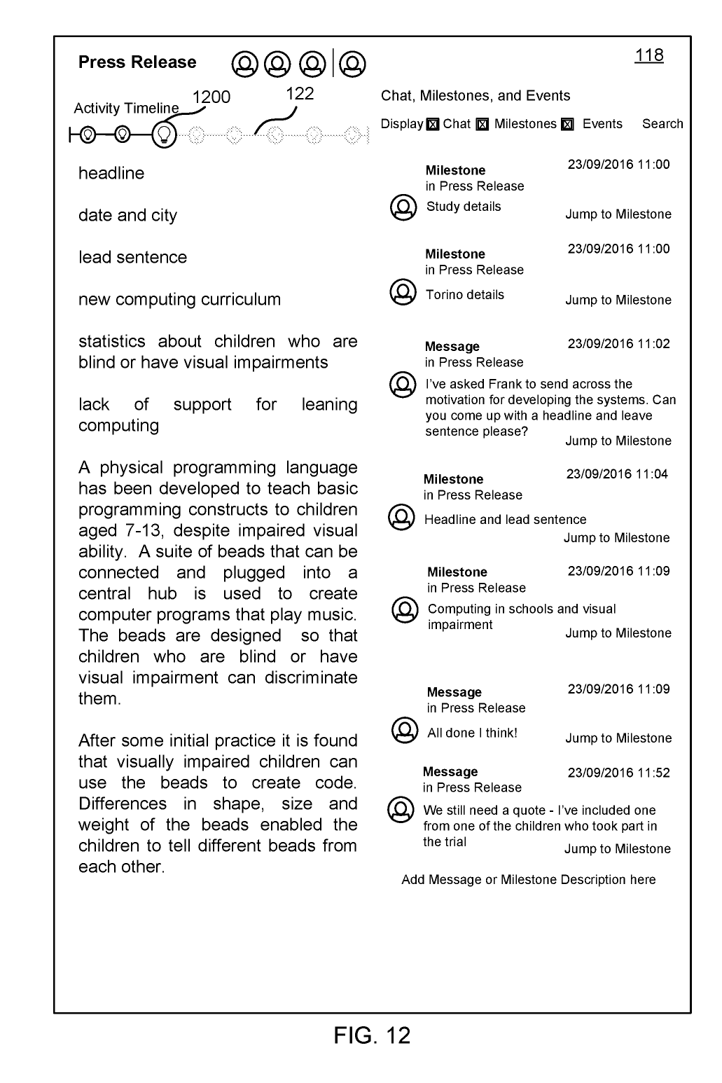

FIG. 12 shows the situation where a user selects an early element 1200 on the document state timeline. The early state of the document is retrieved and displayed in the document pane. The later document states are greyed out on the document state timeline. The chat interface 118 scrolls automatically in synchrony with the document state timeline so that the chat messages which occurred around the same time as the document state are visible in the chat history display.

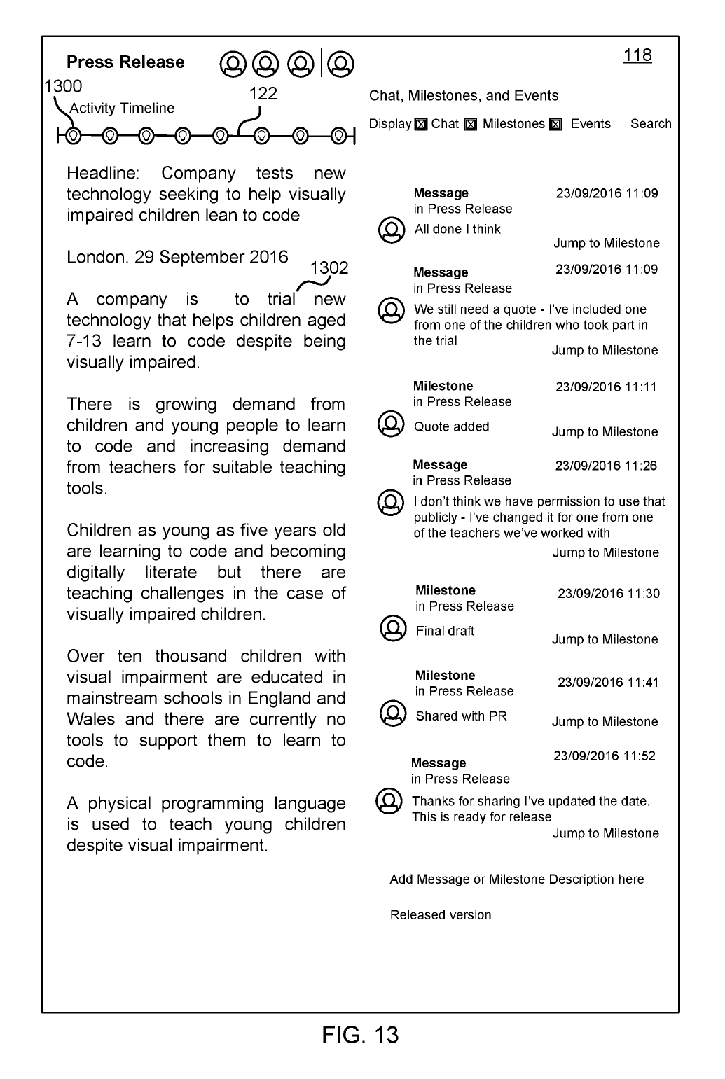

FIG. 13 shows the situation where a user deselects a milestone element 1300 on the document state timeline. In this case the retrieval engine retrieves 1302 the most recent document state and displays that at the document pane. The chat message timeline also automatically scrolls to the most recent point. In some examples, if the user selects the vertical line on the right of the document timeline (which represents the latest content state item) the chat interface scrolls to the bottom of the chat history.

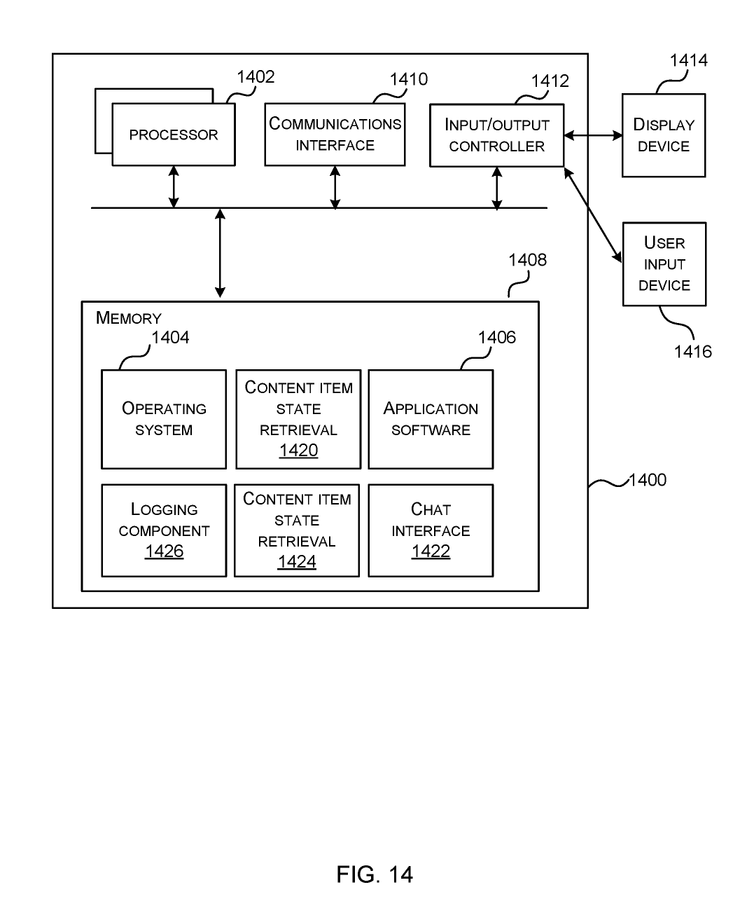

FIG. 14 illustrates various components of an exemplary computing-based device 1400 which are implemented as any form of a computing and/or electronic device, and in which embodiments of a content item state retrieval engine are implemented in some examples.

Computing-based device 1400 comprises one or more processors 1402 which are microprocessors, controllers or any other suitable type of processors for processing computer executable instructions to control the operation of the device in order to retrieve content item state in an efficient manner which reduces burden of data entry for an end user. In some examples, for example where a system on a chip architecture is used, the processors 1402 include one or more fixed function blocks (also referred to as accelerators) which implement a part of the method of FIGS. 6 and 7 in hardware (rather than software or firmware). Platform software comprising an operating system 1404 or any other suitable platform software is provided at the computing-based device to enable application software 1406 to be executed on the device. The application software 1406 includes a chat interface 1422 such as a chat messaging application that communicates with a chat messaging service via communications interface 1410. A logging component 1426 acts to log associations between chat messages at the chat interface 1422 and content item states. The content item states and chat messages are stored at store 1424 and/or a remote store accessed via communications interface 1410. A retrieval engine 1420 retrieves content item states and/or chat messages according to user input selecting elements representing chat messages and/or content item states. The retrieval engine retrieves the content item states and/or chat messages from store 1424 or from any remote entity accessed by communication interface 1410.

The computer executable instructions are provided using any computer-readable media that is accessible by computing based device 1400. Computer-readable media includes, for example, computer storage media such as memory 1408 and communications media. Computer storage media, such as memory 1408, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1408) is shown within the computing-based device 1400 it will be appreciated that the storage is, in some examples, distributed or located remotely and accessed via a network or other communication link (e.g. using communication interface 1410).

The computing-based device 1400 also comprises an input/output controller 1412 arranged to output display information to a display device 1414 which may be separate from or integral to the computing-based device 1400. The display information may provide a graphical user interface. The input/output controller 1412 is also arranged to receive and process input from one or more devices, such as a user input device 1416 (e.g. a mouse, keyboard, camera, microphone or other sensor). In some examples the user input device 1416 detects voice input, user gestures or other user actions and provides a natural user interface (NUI). This user input may be used to select elements of a chat history timeline, select elements of a content item state timeline, select user interface elements to retrieve content item state, and for other purposes. In an embodiment the display device 1414 also acts as the user input device 1416 if it is a touch sensitive display device. The input/output controller 1412 outputs data to devices other than the display device in some examples, e.g. a locally connected printing device.

Any of the input/output controller 1412, display device 1414 and the user input device 1416 may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Alternatively or in addition to the other examples described herein, examples include any combination of the following:

An electronic device having a content item state retrieval system the electronic device comprising:

a chat interface executing at the electronic device;

a processor which monitors states of at least one content item associated with the electronic device in relation to chat messages at the chat interface;

a logging component which logs associations between at least some of the content item states and the chat messages based on the times at which the chat messages were created; and

a user interface having selectable elements representing the chat messages, which when selected by a user trigger retrieval of an associated state of a content item based on the logged associations.

The electronic device described above wherein the logging component logs an association between a content item state and a chat message if the time at which the chat message was created is within a range of a time of the content item state.

The electronic device described above wherein the user interface comprises selectable elements representing at least some of the content item states, which when selected by a user trigger retrieval of associated chat messages.

The electronic device described above wherein the selectable elements representing the chat messages are on a chat timeline.

The electronic device described above wherein the chat timeline further comprises one or more selectable elements representing content item states.

The electronic device described above wherein the selectable elements represent content item states which are on the chat timeline are added in response to user input.

The electronic device described above wherein the selectable elements representing the content item states are on a content item state timeline.

The electronic device described above wherein the selectable elements representing the content item states are of a plurality of different classes.

The electronic device described above wherein the logging component comprises a filter configured to select content item states to be logged, the filter using criteria which are configured according to user input and/or context of the content item states.

The electronic device described above wherein the user interface is configured such that when a selectable element representing a content item state is de-selected, retrieval of a current state of the content item is triggered.

The electronic device described above comprising a log at the electronic device or at a remote entity in communication with the electronic device, the log storing the associations and the content item states.

A computer-implemented method at an electronic device comprising:

executing a chat interface at the electronic device;

receiving, at a processor, states of at least one content item associated with the electronic device in relation to chat messages at the chat interface;

logging associations between at least some of the content item states and the chat messages based on the times at which the chat messages were created; and

generating selectable elements representing the chat messages at a user interface;

receiving user input selecting one of the selectable elements and, in response, retrieving the associated state of the content item.

The computer-implemented method described above comprising logging an association between a content item state and a chat message if the time at which the chat message was created is within a range of a time of the content item state.

The computer-implemented method described above comprising generating selectable elements representing at least some of the content item states, which when selected by a user trigger retrieval of associated chat messages.

The computer-implemented method described above comprising using a timeline to represent the chat messages.

The computer-implemented method described above comprising adding one or more selectable elements representing content item states to the timeline of chat messages.

A content item state retrieval system comprising:

a processor configured to monitor states of at least one content item in relation to chat messages at a chat interface executing at one or more electronic devices;

a log storing associations between at least some of the content item states and the chat messages based on times at which the chat messages were created;

a retrieval engine configured to retrieve content item states from the log according to user selection of selectable elements representing the chat messages at a user interface.

The content item state retrieval system described above wherein the log stores an association between a content item state and a chat message if the time at which the chat message was created is within a range of a time of the content item state.

The content item state retrieval system described above wherein the retrieval engine is configured to retrieve chat messages associated with content item states

The content item state retrieval system described above wherein the retrieval engine is configured to retrieve the chat messages from the log according to user selection of selectable elements representing the content item states.

An electronic device comprising:

means for executing a chat interface at the electronic device;

means for receiving states of at least one content item associated with the electronic device in relation to chat messages at the chat interface;

means for logging associations between at least some of the content item states and the chat messages based on the times at which the chat messages were created; and

means for generating selectable elements representing the chat messages at a user interface; and means for receiving user input selecting one of the selectable elements and, in response, retrieving the associated state of the content item. For example, the means for executing a chat interface comprises a processor executing instructions which implement a chat interface and which work together with a chat messaging service. For example, the means for receiving states comprises the processor and the means for logging associations comprises the logging component. The means for generating selectable elements and receiving user input comprises the processor.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. An electronic device having a content item state retrieval system the electronic device comprising:
a chat interface executing at the electronic device;
a processor which monitors states of at least one content item associated with the electronic device in relation to chat messages at the chat interface;
a logging component which logs associations between at least some of the content item states and the chat messages based on the times at which the chat messages were created; and
a user interface having selectable elements representing the chat messages, which when selected by a user trigger retrieval of an associated state of a content item based on the logged associations.

2. The electronic device of claim 1 wherein the logging component logs an association between a content item state and a chat message if the time at which the chat message was created is within a range of a time of the content item state.

3. The electronic device of claim 1 wherein the user interface comprises selectable elements representing at least some of the content item states, which when selected by a user trigger retrieval of associated chat messages.

4. The electronic device of claim 1 wherein the selectable elements representing the chat messages are on a chat timeline.

5. The electronic device of claim 4 wherein the chat timeline further comprises one or more selectable elements representing content item states.

6. The electronic device of claim 4 wherein the selectable elements represent content item states which are on the chat timeline are added in response to user input.

7. The electronic device of claim 3 wherein the selectable elements representing the content item states are on a content item state timeline.

8. The electronic device of claim 3 wherein the selectable elements representing the content item states are of a plurality of different classes.

9. The electronic device of claim 3 wherein the user interface is configured such that when a selectable element representing a content item state is de-selected, retrieval of a current state of the content item is triggered.

10. The electronic device of claim 1 wherein the logging component comprises a filter configured to select content item states to be logged, the filter using criteria which are configured according to user input and/or context of the content item states.

11. The electronic device of claim 1 comprising a log at the electronic device or at a remote entity in communication with the electronic device, the log storing the associations and the content item states.

12. A computer-implemented method at an electronic device comprising:
executing a chat interface at the electronic device;
receiving, at a processor, states of at least one content item associated with the electronic device in relation to chat messages at the chat interface;
logging associations between at least some of the content item states and the chat messages based on the times at which the chat messages were created; and
generating selectable elements representing the chat messages at a user interface;
receiving user input selecting one of the selectable elements and, in response, retrieving the associated state of the content item.

13. The computer-implemented method of claim 12 comprising logging an association between a content item state and a chat message if the time at which the chat message was created is within a range of a time of the content item state.

14. The computer-implemented method of claim 12 comprising generating selectable elements representing at least some of the content item states, which when selected by a user trigger retrieval of associated chat messages.

15. The computer-implemented method of claim 12 comprising using a timeline to represent the chat messages.

16. The computer-implemented method of claim 12 comprising adding one or more selectable elements representing content item states to the timeline of chat messages.

17. A content item state retrieval system comprising:
a processor configured to monitor states of at least one content item in relation to chat messages at a chat interface executing at one or more electronic devices;
a log storing associations between at least some of the content item states and the chat messages based on times at which the chat messages were created; and
a retrieval engine configured to retrieve content item states from the log according to user selection of selectable elements representing the chat messages at a user interface.

18. The content item state retrieval system of claim 17 wherein the log stores an association between a content item state and a chat message if the time at which the chat message was created is within a range of a time of the content item state.

19. The content item state retrieval system of claim 17 wherein the retrieval engine is configured to retrieve chat messages associated with content item states

20. The content item state retrieval system of claim 19 wherein the retrieval engine is configured to retrieve the chat messages from the log according to user selection of selectable elements representing the content item states.
